(19) United States
(12) Patent Application Publication
(10) Pub. No.: US 2022/0392336 A1
(43) Pub. Date: Dec. 8, 2022

(54) VEHICLE TO INFRASTRUCTURE INFORMATION SHARING AND INFRASTRUCTURE CONTROL BASED ON THE INFORMATION

(71) Applicant: Toyota Motor Engineering & Manufacturing North America, Inc, Plano, TX (US)

(72) Inventor: Geoffrey D. Gaither, Ann Arbor, MI (US)

(73) Assignee: Toyota Motor Engineering & Manufacturing North America, Inc, Plano, TX (US)

(21) Appl. No.: 17/336,608

(22) Filed: Jun. 2, 2021

(51) Int. Cl. G08G 1/08; G07C 5/00; G07C 5/02; G07C 5/08; H04W 4/44

(52) U.S. Cl. CPC G08G 1/08; G07C 5/008; G07C 5/02; G07C 5/0841; H04W 4/44

(57) ABSTRACT

Methods and systems may provide for technology to identify that a transmission includes one or more of vehicle sensor data sensed by a vehicle or at least one feature identified from the vehicle sensor data. The vehicle is associated with vehicle identification data unique to the vehicle. The technology also identifies that the vehicle identification data is associated with the transmission, identifies that one or more parameters that are associated with the vehicle identification data, and adjusts at least one parameter of the identified one or more parameters.

### TECHNICAL FIELD

Embodiments generally relate to a vehicle-to-infrastructure (V2I) information analysis and parameter control. More particularly, embodiments relate to adjusting one or more parameters associated with a unique vehicle identification based on the information.

### BACKGROUND

Some vehicles include communication devices to communicate with infrastructure. Vehicle-to-Infrastructure (V2I) communication is a bidirectional wireless exchange of data between vehicles and road infrastructure. V2I communication enables the infrastructure to receive the data and take actions based on the data. V2I communications are growing in capability and volume as the technology expands nationally and globally. As more infrastructure (e.g., roadside units, traffic lights, specialized units, etc.) become available to receive messages from broadcasting vehicles, the usage, application and analysis of that information grows.

One of the main benefits of V2I communication is enhanced safety and congestion management. In order to maintain accurate maps and keep local municipalities informed of pedestrian and non-road traffic, the infrastructure database may require regular updating and time-based information streams. Such updating and time-based information streams may be irregularly updated, incur significant financial costs, and require significant manual labor to maintain and update.

### BRIEF SUMMARY

Some embodiments include a computing device comprising a transmission interface to receive a transmission, a processor, and memory having a set of instructions, which when executed by the processor, cause the computing device to identify that the transmission includes one or more of vehicle sensor data sensed by a vehicle or at least one feature identified from the vehicle sensor data, wherein the vehicle is associated with vehicle identification data unique to the vehicle, identify that the vehicle identification data is associated with the transmission, identify one or more parameters that are associated with the vehicle identification data, and adjust at least one parameter of the identified one or more parameters.

Some embodiments include a vehicle comprising a transmission interface that transmits a first transmission to a computing device, a sensor to detect vehicle sensor data, and a vehicle controller including a processor, and memory having a set of instructions, which when executed by the processor, cause the vehicle controller to determine whether or not the vehicle sensor data includes updated data dissimilar from historical data, and determine that the updated data is to be part of the first transmission in response to the vehicle sensor data being determined to include the updated data, wherein the updated data is one or more of the vehicle sensor data or one or more features identified from the vehicle sensor data that are dissimilar from the historical data.

Some embodiments include at least one computer readable storage medium comprising a set of instructions, which when executed by a computing device, cause the computing device to identify that a transmission includes one or more of vehicle sensor data sensed by a vehicle or at least one feature identified from the vehicle sensor data, wherein the vehicle is associated with vehicle identification data unique to the vehicle, identify that the vehicle identification data is associated with the transmission, identify one or more parameters that are associated with the vehicle identification data, and adjust at least one parameter of the identified one or more parameters.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 is an example of a V2I system for processing non-roadway users according to an embodiment;

FIG. 2 is an example of a V2I system for mitigating a traffic-surge according to an embodiment;

FIG. 3 is an example of a reporting process for a V2I process according to an embodiment;

FIG. 4 is a flowchart of an example of a method of V2I construction and pedestrian information sharing according to an embodiment;

FIG. 5 is a flowchart of an example of a method of V2I non-road user and roadway information sharing according to an embodiment;

FIG. 6 is a flowchart of an example of a method of V2I information sharing during an event that will generate a significant increase in traffic according to an embodiment; and

FIG. 7 is a block diagram of an example of a V2I system according to an embodiment.

### DETAILED DESCRIPTION

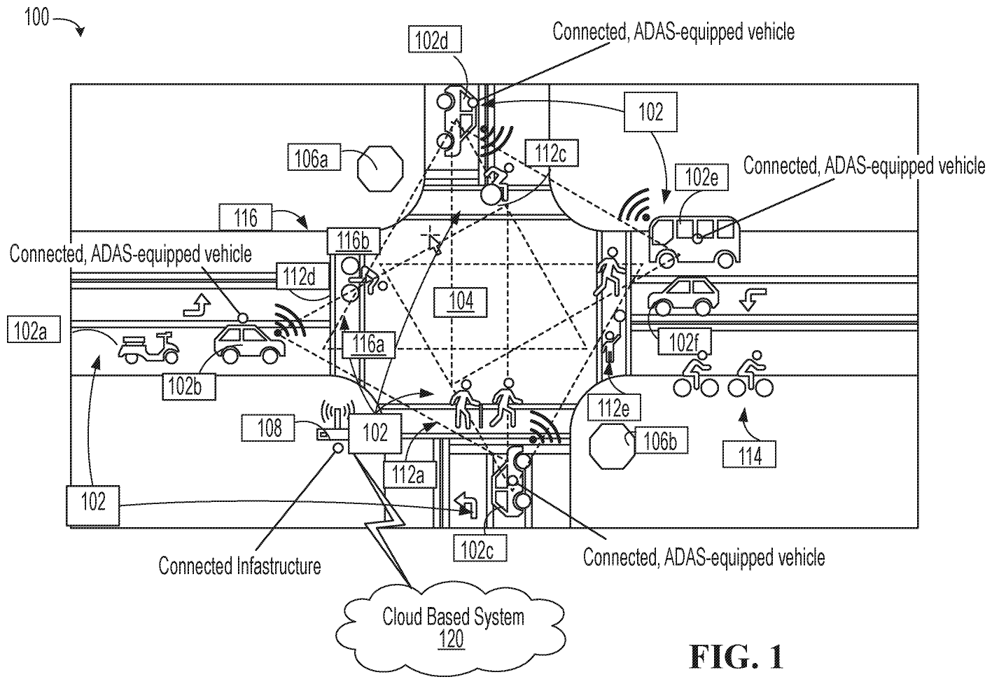

FIG. 1 illustrates a V2I system 100 in which vehicles 102 are positioned at an intersection 104. A subset of the vehicles 102b-102e participate in an enhanced V2I process in which infrastructure 108 (e.g., a computing device including a transceiver and/or receiver, a server, etc.) and cloud based management system 120 (e.g., a computing device such as a server) dynamically retrieve information from the subset of vehicles 102b-102e. The infrastructure 108 and/or cloud based management system 120 analyzes the information and adjusts different parameters to enhance traffic flows, pedestrian usage, increase overall transportation efficiency and reward the subset of vehicles 102b-102e. The V2I system 100 automates collection of information, particularly with respect to crosswalk users 112a-112e and other non-automotive users that may be difficult to otherwise track. Furthermore, the V2I system 100 not only senses crosswalk users 112a-112e (and other non-roadway users), but also analyzes the information to detect granular characteristics of the crosswalk users 112a-112e, including position, trajectory, and velocity. Furthermore, based on such information, the infrastructure 108 may specifically adjust operating parameters to reward the subset of vehicles 102b-102e and/or enhance traffic flows.

The vehicles 102 include a first vehicle 102a, a second vehicle 102b, a third vehicle 102c, a fourth vehicle 102d, a fifth vehicle 102e and a sixth vehicle 102f The subset of the vehicles 102b-102e that participate in the V2I process include the second vehicle 102b, the third vehicle 102c, the fourth vehicle 102d and the fifth vehicle 102e. The first and sixth vehicles 102a, 102f may not participate in the V2I process, either due to a lack of appropriate sensors and/or communication protocols, or a driver opting out of participating.

The subset of vehicles 102b-102e transfers information to the infrastructure 108 and/or cloud based management system 120. The information may include sensor data and/or features determined from the sensor information. For example, the vehicles 102 may process the information to identify features from the sensor data. For example, the second vehicle 102b may include a sensor (e.g., an imaging sensor, LiDAR sensor, proximity sensor, etc.) that detects a bicyclist 112d is on a crosswalk 116 of intersection 104. The second vehicle 102b may then determine characteristics of the bicyclist 112d, including a velocity, a position, a trajectory, a predicted future position, a prediction of when the bicyclist 112d will cross the crosswalk 116, a duration of time that the bicyclist 112d took to complete crossing the crosswalk 116, etc. associated with the bicyclist 112d. The second vehicle 102b provides the sensor data and/or the features to the infrastructure 108 and/or cloud based management system 120.

In some examples, raw sensor data is provided to the infrastructure 108 and/or cloud based management system 120, and the sensor data is provided to the infrastructure 108 to analyze the raw sensor data to determine features from the raw sensor data. While infrastructure 108 is described below, it will be understood that the cloud based management system 120 may process the sensor data to determine characteristics, and provide the characteristics and/or instructions to the infrastructure 108 to control traffic flows.

Similarly, the third vehicle 102c, the fourth vehicle 102d and the fifth vehicle 102e also provide sensor data and/or features to the infrastructure 108 and/or cloud based management system 120. The first and sixth vehicles 102a, 102f do not participate in the above described process, and thus do not transmit information to the infrastructure 108 and/or cloud based management system 120.

In some embodiments, the sensor data from a single vehicle of the subset of vehicles 102b-102e may be inadequate to accurately determine the above described features, such as trajectory and/or velocity. Accordingly, the infrastructure 108 and/or cloud based management system 120 may receive the sensor data from the subset of the vehicles 102b-102e, and aggregate the sensor data together and process the aggregated sensor data to determine the features.

For example, the bicyclist 112d is only within a detection area of the sensor of the second vehicle 102b for a first portion 116a of the crosswalk 116, while a second portion 116b of the crosswalk 116 is undetectable, not sensed and/or unobservable by the sensor of the second vehicle 102b. The detection area is illustrated as a triangle with a vertex adjacent to and nearly overlying the second vehicle 102b. The fourth vehicle 102d may include a sensor that has a detection area including the second portion 116b of the crosswalk 116 that is unobservable by the second vehicle 102b. The detection area of the fourth vehicle 102d is illustrated as a triangle with a vertex overlying the fourth vehicle 102d. That is, the fourth vehicle 102d senses the second portion 116b. Thus, the sensor data of the second vehicle 102b is inadequate for mapping a complete path and movement of the bicyclist 112d across the crosswalk 116. As such, the infrastructure 108 and/or cloud based management system 120 may combine the sensor data of the second and fourth vehicles 102b, 102d to determine characteristics of bicyclist 112d across the entire crosswalk 116. Thus, the infrastructure 108 and/or cloud based management system 120 accurately determines the characteristics (e.g., velocity, trajectory, etc.) of the bicyclist 112d across the entire crosswalk 116 based on the combined and/or aggregated sensor data of the second and fourth vehicles 102b, 102d. It is worthwhile to note that the third vehicle 102c and fifth vehicle 102e have corresponding detection areas that are formed as triangles including a vertex that overlies the respective third vehicle 102c and fifth vehicle 102e.

For example, the infrastructure 108 and/or cloud based management system 120 may receive in a first transmission, the sensor data from the second vehicle 102b. The infrastructure 108 and/or cloud based management system 120 may identify an approximate position and area sensed, represented and/or encompassed by the sensor data of the second vehicle 102b. In this example, the area corresponds to the first portion 116a of the crosswalk 116. The infrastructure 108 and/or cloud based management system 120 may then receive in a second transmission, sensor data from the other vehicles of the subset of vehicles 102b-102e that encompass and/or represent areas adjacent to the first portion 116a. In this example, the infrastructure 108 and/or cloud based management system 120 identifies that the sensor data of the fourth vehicle 102d encompasses the second portion 116b which is an area adjacent to the first portion 116a. For example, the infrastructure 108 and/or cloud based management system 120 may identify an approximate position of the area encompassed by the sensor data of the fourth vehicle 102d.

In some examples, the infrastructure 108 and/or cloud based management system 120 identifies overlapping points-of-interest, such as the crosswalk 116, common in the sensor data of the second and fourth vehicles 102b, 102d to determine that the sensor data of the fourth vehicle 102d encompasses an area adjacent to the first portion 116a. The infrastructure 108 and/or cloud based management system 120 may then aggregate the sensor data of the second vehicle 102b and the fourth vehicle 102d based on the identification that the areas encompassed and/or represented by the sensor data are adjacent to each other. Doing so may enable tracking of points-of-interest across a wider area range that is sensed by several sensors from different vehicles of the subset of vehicles 102b-102e.

Similarly, the infrastructure 108 and/or cloud based management system 120 receives sensor data from the second vehicle 102b, the third vehicle 102c and the fifth vehicle 102e to determine different characteristics of the pedestrians 112a. For example, the infrastructure 108 and/or cloud based management system 120 identifies the velocity and/or trajectory of the pedestrians 112a across the crosswalk by analyzing the received sensor data. Furthermore, as illustrated, sensor data (e.g., images and/or video) of the pedestrians 112a are captured from multiple angles and positions. The infrastructure 108 and/or cloud based management system 120 analyzes the pedestrians 112a from the multiple angles to determine walking angles, trajectories, deviations, etc. at a fine granularity. That is, sensor data from the third vehicle 102c may be analyzed to detect a first characteristics (e.g., velocity) of the pedestrians 112a, while sensor data of the second and fifth vehicles 102b, 102e may be analyzed to detect second characteristics (e.g., trajectory and/or side-to-side movements) of the pedestrians 112a.

For example, the third vehicle 102c detects a side profile of the pedestrians 112a. A velocity may be accurately detected based on the side profile, but other characteristics may be difficult to accurately determine. Thus, the infrastructure 108 and/or cloud based management system 120 may detect a velocity (e.g., a forward movement) of the pedestrians 112a based on the side profile. The second and fifth vehicles 102b, 102e capture sensor data (e.g., images and/or video) of the back and front of the pedestrians 112a (e.g., back and front profiles). Trajectory and the side-to-side movements may be accurately detected based on the back and front profiles, but other characteristics may be more difficult to detect. The infrastructure 108 and/or cloud based management system 120 may determine a trajectory and side-to-side movements of the pedestrians 112a based on the front and back profiles.

Thus, the infrastructure 108 and/or cloud based management system 120 may detect the movements of the pedestrians in different dimensions based on the combined sensor data. For example, the infrastructure 108 and/or cloud based management system 120 detects movements of the pedestrians 112a in a first direction (e.g., an x-direction to move forward across the crosswalk) from the side profile, and movements of the pedestrians 112a in a second direction perpendicular to the first direction (e.g., a y-direction or side-to-side within the crosswalk) from the front and back profiles.

Similarly, the fourth vehicle 102d, the fifth vehicle 102e and the second vehicle 102b may detect the presence of a wheelchair user 112c. The infrastructure 108 may analyze the aggregated sensor data of the fourth vehicle 102d, the fifth vehicle 102e and the second vehicle 102b to detect various features of the wheelchair user 112c, such as how long the wheelchair user 112c takes to cross the intersection. In some examples, the wheelchair user 112c may be identified as utilizing a wheelchair from the aggregated sensor data. As a consequence, the infrastructure 108 and/or cloud based management system 120 may adjust the intersection 104 to enhance accessibility for wheelchair users. For example, the infrastructure 108 may generate warnings (e.g., auditory or visual) to automotive users to not block crosswalks and/or adjust timings of signals 106a, 106b.

Similarly, the infrastructure 108 and/or cloud based management system 120 may analyze aggregated sensor data of the fifth vehicle 102e, third vehicle 102c and fourth vehicle 102d to identify characteristics of pedestrians 112e. Furthermore, the infrastructure 108 and/or cloud based management system 120 may analyze sensor data of the vehicles 102 to detect non-cross walk users 114 along the roadway. The non-cross walk users 114 may be traveling towards a second intersection. The infrastructure 108 and/or cloud based management system 120 may pre-emptively adjust the signaling at the second intersection in response to the identification that the non-cross walk users 114 are travelling towards the second intersection. For example, the signaling at the second intersection may be adjusted to minimize and/or reduce the amount of time that the non-cross walk users 114 will wait at the second intersection before crossing the second intersection.

Some embodiments utilize sensors (e.g., on-board cameras, etc.) to detect pedestrians and other non-road users (scooters riders, cyclists, etc.) and determine their trajectories. Based on their trajectories or current position, the V2I system 100 records the information to a centralized database such as a cloud based management system 120. The cloud based management system 120 may aggregate sensor data from the subset of vehicles 102b-102e in the centralized database. The sensor data and/or features detected from the sensor data may be shared with other elements of the infrastructure 108. Thus, some embodiments employ crowd-sourcing and through artificial intelligence and/or machine learning confirm the presence of pedestrians and/or non-road users.

In some examples, the subset of vehicles 102b-102e may receive right-of-way preferencing, or other benefits for participating in the V2I system 100. For example, the vehicles 102b-102e may have preferential signaling at other intersections (not illustrated) in exchange for providing data to the infrastructure 108 and/or cloud based management system 120. For example, wait times at the other intersections for the subset of vehicles 102b-102e may be eliminated, reduced or minimized such that these vehicles are given earlier access to the right of way.

For example, each of the subset of vehicles 102b-102e may include vehicle identification data. The vehicle identification data may be unique. The infrastructure 108 may read the vehicle identification data to change one or more parameters associated with the vehicle identification data. For example, each of respective vehicle the subset of vehicles 102b-102e may include a unique RFID tag, license plate, etc. that the infrastructure 108 reads to permit the tracking of the respective vehicle. The infrastructure 108 and/or cloud based management system 120 may identify one or more parameters associated with the vehicle identification data of the respective vehicle and adjust the one or more parameters based on the sensor data provided by the respective vehicle to the infrastructure 108.

For example, the one or more parameters may relate to prioritized signaling. Thus, the respective vehicle may enjoy prioritized signaling to reduce wait times at stop lights. For example, the respective vehicle may be tracked. The infrastructure 108 and/or cloud based management system 120 may identify when the respective vehicle is approaching a second intersection, and adjust the signaling to provide the respective vehicle with the right of way at the intersection and prior to the respective vehicle reaching the intersection (e.g., change a red light to a green light).

In some examples, the one or more parameters may relate to one or more parameters that are disassociated from and/or unrelated to the intersection 104. For example, the one or more parameters may relate to increased access. For example, some parking zones and/or highways may be inaccessible without payment and/or unless permission is granted. Some embodiments may adjust the one or more parameters such that the respective vehicle may access the parking zones and/or highways without payment or at a reduced payment, and/or with permission.

In some examples, the infrastructure 108 and/or cloud based management system 120 may transmit to a user of the respective vehicle, the one or more parameters (e.g., prioritized signaling, reduced payment, access to typically restricted zones, etc.). The user may review the one or more parameters and select at least one parameter of the one or more parameters for adjustment. The selected at least one parameters may be adjusted, while unselected parameters may not be adjusted. Infrastructure 108 may thus receive the selected at least one parameter and adjust the selected at least one parameter.

In some examples, the subset of vehicles 102b-102e are advanced driver-assistance system equipped. In some examples, the subset of vehicles 102b-102e further provide sensor data (e.g., position, images, number, etc.) associated with vehicles, such as the first vehicle 102a and the sixth vehicle 102f that do not participate in the V2I process. In some examples, the V2I process executes each time vehicles, such as vehicles 102, are stopped at an intersection to retrieve sensor data from the vehicles.

In some examples, the sensor data is associated with weather conditions (e.g., rain, icy roads, foggy, sunny, snowing, icy, etc.). The infrastructure 108 and/or cloud based management system 120 may then determine actions to take based on the weather conditions, such as pushing alerts to other vehicles. For example, if the sensor data of the subset of vehicles 102b-102e indicates that the roadways are icy, the infrastructure 108 and/or cloud based management system 120 may notify other vehicles to reroute away from icy conditions. The infrastructure 108 and/or cloud based management system 120 may also push a notification to a winter service vehicle to clear roadways.

In the above examples, the infrastructure 108 processes sensor data of the subset of vehicles 102b-102e. It will be understood that the division of operations is flexible, and in some embodiments the subset of vehicles 102b-102e may identify objects from sensor data, and characteristics of the objects. The subset of vehicles 102b-102e may then transmit the identified objects and characteristics (e.g., processed data) to the infrastructure 108 and/or cloud based management system 120 rather than raw sensor data alone. Furthermore, the division of operations between the infrastructure 108 and/or cloud based management system 120 is flexible.

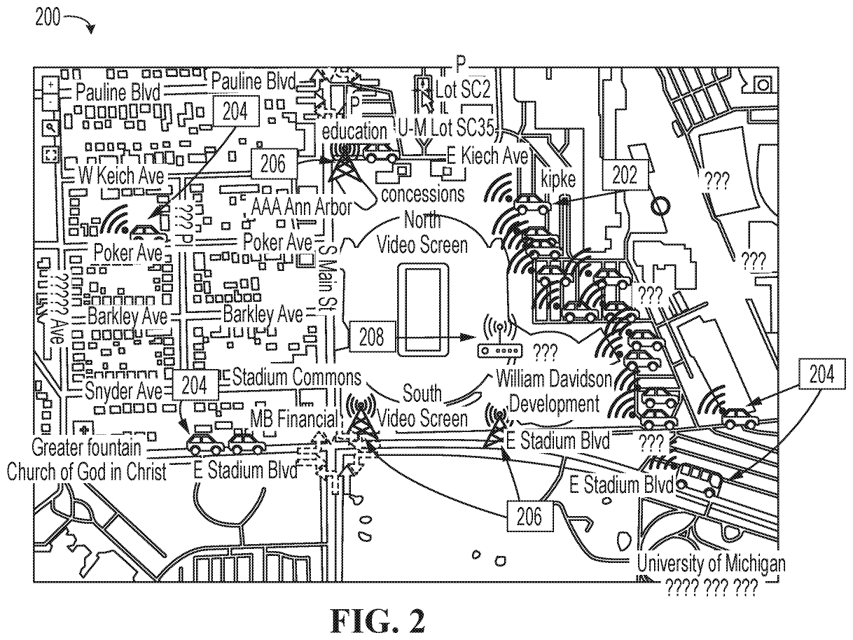

FIG. 2 illustrates an engagement process for a V2I system 200 to mitigate a traffic-surge associated an event. In the V2I system 200, first vehicles 202 and second vehicles 204 are connected to infrastructure 208. The infrastructure 208 may be connected to a cloud (not illustrated) as described above and/or include a cloud based structure. The operations of the infrastructure 208 may be executed by the cloud when desired.

The infrastructure 208 receives data from the first vehicles 202 and second vehicles 204 to control traffic. In detail, a stadium may host an event. Attendees in the event may park the first vehicles 202 at a stadium parking lot of the stadium while the attendees attend the event. After the event completes, most of the attendees may leave the stadium in the first vehicles 202 generating a temporary, but significant, increase in traffic flow.

Thus, in some embodiments, the infrastructure 208 may connect with the first vehicles 202 to predict when traffic will significantly increase (e.g., after the event completes) and adjust traffic logic to control the flow of traffic. For example, the infrastructure 208 may determine when a predetermined number of the first vehicles 202 are actuated. The predetermined number may correspond to completion of the event and the departure of attendees from the parking lot in the first vehicles 202. When the infrastructure 208 detects that the predetermined number of first vehicles 202 is actuated, the infrastructure 208 triggers modified traffic signal controls to minimize congestion. For example, the infrastructure 208 may execute prioritized signaling to increase traffic flow away from the parking lot guide the first vehicles 202 away from the stadium area (e.g., maintain green lights for longer periods of time to permit exiting from the stadium and/or away from the stadium).

In some embodiments, the infrastructure 208 may further receive data related to engaged gears of the first vehicles 202. For example, if the first vehicles 202 are in park and/or neutral gear, the infrastructure 208 may extrapolate that the first vehicles 202 are not presently leaving the parking lot. When a predetermined number of the first vehicles 202 shift into a gear associated with movement (e.g., drive, reverse, low gear, etc.) the infrastructure 208 may then execute the prioritized signaling.

In some examples, the infrastructure 208 may analyze environmental signals to predict a traffic surge. For example, the infrastructure 208 may analyze auditory and/or visual signals to determine when the first vehicles 202 are actuated. For example, the infrastructure 208 may analyze auditory signals to determine that the first vehicles 202 that the engines are actuated. The infrastructure 208 may analyze visual signals (e.g., thermal images) to determine that heat is emanating from engines of the first vehicles 202, and thus that the first vehicles 202 are actuated. The first vehicles 202, or local sensors, may provide the environmental signals. The infrastructure 208 may execute the prioritized signaling to guide the first vehicles 202 away from the stadium area in response to the auditory and/or visual signals indicating that a predetermined number of engines are actuated.

The infrastructure 208 may also be connected to second vehicles 204 as well. The second vehicles 204 may provide real-time feedback to the infrastructure 208 about areas surrounding the stadium. For example, the second vehicles 204 may provide data related to pedestrian volume on roadways, traffic flows on the roadways, road conditions, etc. The infrastructure 208 may execute the prioritized signaling based on the data from the second vehicles 204 to bypass routing the second vehicles 204 to congested areas (e.g., areas with high pedestrian volume, congested, etc.). Thus, the infrastructure 208 may not only route traffic based on the data from the first vehicles 202, but also based on real-time data feeds associated with surrounding areas from the second vehicles 204.

Regardless of a particular basis for detecting that prioritized signaling should occur, once the infrastructure 208 is triggered to begin prioritized signaling, the infrastructure 208 may communicate with connected infrastructure 206 to communicate data, for example if a surge in traffic is expected. The connected infrastructure 206 may take actions based on the predicted surge, such as routing traffic away from congested areas surrounding the stadium. For example, the connected infrastructure 206 may instruct other vehicles to avoid the stadium locality and/or prioritize signaling to guide first vehicles 202 away from the stadium area at a greater traffic flow. Thus, some embodiments may predict traffic surges prior to the surges occurring and based on dynamic and real time information from vehicles.

In some examples, the V2I system 200 detects when a significant amount vehicles are travelling to the parking lot and similarly to as described above. In such a case, the V2I system 200 may control signaling to direct traffic flow in an increased manner to the parking lot.

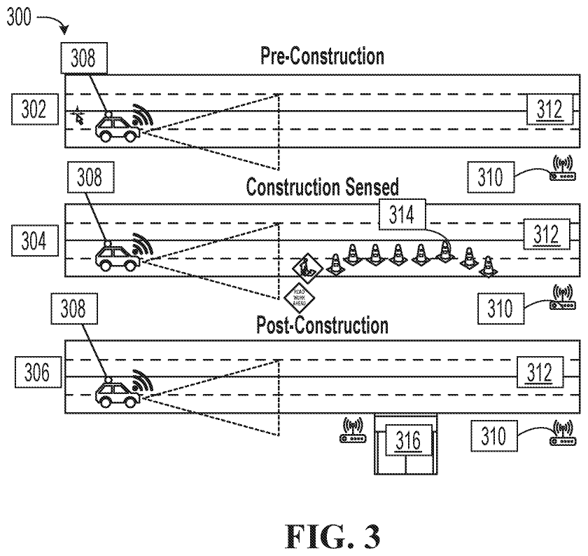

FIG. 3 illustrates a reporting process 300 to update infrastructure 310 about modifications to a roadway 312. In the process 300, the infrastructure 310 may be connected to a cloud similar to a cloud (not illustrated) as described above. The operations of the infrastructure 310 may be executed by the cloud when desired.

The reporting process 300 includes a vehicle 308 that traverses the roadway 312. During a pre-construction scenario 302, the roadway 312 is free of construction. To determine whether to update the infrastructure 310, the vehicle 308 may compare currently sensed conditions to previous roadway 312 conditions.

During the pre-construction scenario 302, the vehicle 308 may not sense any deviations from previous roadway 312 conditions. For example, the vehicle 308 may store historical data of the roadway 312 conditions. The historical conditions may be stored locally in a non-volatile memory of the vehicle 308. The vehicle 308 may compare currently sensed roadway conditions to the historical data. If a deviation is detected, the infrastructure 310 may be updated. In the pre-construction scenario 302, the vehicle 308 does not detect any deviation, and thus no update is provided to the infrastructure 310.

Thereafter, a construction scenario 304 may occur. In the construction scenario 304, the vehicle 308 may sense deviations from roadway 312 conditions. For example, the historical data may indicate that the roadway 312 is free of construction as illustrated in the pre-construction scenario 302. In contrast, the vehicle 308 senses construction zone 314 which includes several objects (e.g., cones, signs, etc.) indicating construction is present. Thus, the vehicle 308 determines that a deviation is present in construction zone 314, and updates the infrastructure 310 accordingly. That is, the vehicle 308 updates the infrastructure 310 that the construction zone 314 is now present. The vehicle 308 may only provide details associated with the deviation to the infrastructure 310 while bypassing other details that are not deemed to be deviations.

The infrastructure 310 may analyze the deviations and execute operations accordingly. For example, the infrastructure 310 may guide vehicles away from the construction zone 314. The infrastructure 310 may also warn vehicles that the construction zone 314 exists and to maintain a slow velocity. The infrastructure 310 may also measure characteristics of the construction, such as how long workers remain on the construction zone 314, whether safety protocols are being met and so forth. In some examples, the infrastructure 310 may aggregate sensor data from a plurality of vehicles that sense the construction zone 314 to measure the characteristics.

In some embodiments, when the vehicle 308 passes through the construction zone 314, the vehicle 308 may experience a lane shift or other changes to normal driving behavior as indicated in historical records. As the vehicle 308 is already learning these changes either to support advanced driving automated systems or for fuel economy improvement, the same information may trigger or initiate an update to the infrastructure 310 that a construction event is occurring. Thus, changes in the driver's behavior may initiate an update to the infrastructure 310.

Thereafter in the post-construction scenario 306, the vehicle 308 may identify that a deviation exists from the historical data. For example, the historical data may indicate that the roadway 312 includes construction zone 314 as illustrated in the construction scenario 304. In contrast, the vehicle 308 senses that the construction area 314 no longer is present. Furthermore, the historical data may not include a new roadway 316. The deviations, including the lack of the construction zone 314 and the new roadway 316, may be transmitted to the infrastructure 310. The infrastructure 310 may in turn take actions based on the deviations, including routing vehicles to the new roadway 316 and eliminating routing traffic based the construction zone 314 (which is no longer present).

In some examples, a change to the driver behavior may be recognized and tracked. Thus, when the post-construction scenario 306 occurs, another update to the infrastructure 310 may occur. The new traffic behavior and road-side structures may be perceived by the vehicle 308 and then shared with the infrastructure 310.

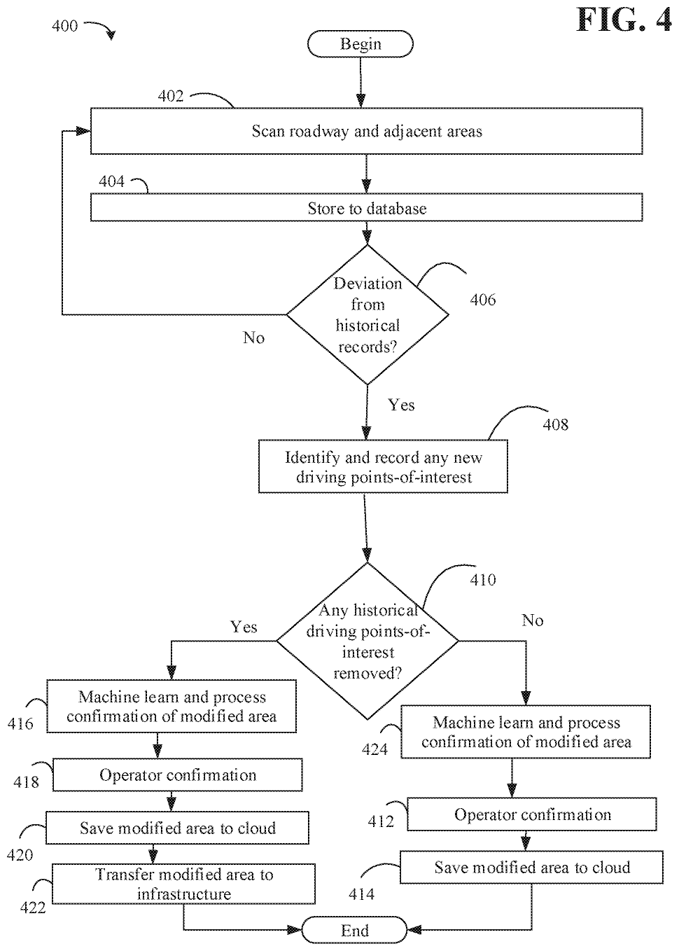

FIG. 4 illustrates a method 400 of V2I construction and pedestrian information sharing. The method 400 may generally be implemented in infrastructure and/or a vehicle. In an embodiment, the method 400 is implemented in logic instructions (e.g., software), configurable logic, fixed-functionality hardware logic, etc., or any combination thereof. In some embodiments, the method 400 is implemented as part of the reporting process 300.

Illustrated processing block 402 scans a roadway and adjacent areas. For example, processing block 402 includes using a camera, a LiDAR sensor, radar scanner, etc. to scan the roadways and adjacent areas. Additionally, processing block 402 identifies information associated with the vehicle, such as vehicle position, vehicle proximity to infrastructure, vehicle speed, steering angle, vehicle heading, lane selection, nearby vehicle positions, proximity of nearby vehicles, estimated trajectories of nearby vehicles road signs, lane markings, cones/barriers, equipment associated with construction and so forth.

Illustrated processing block 404 stores the scanned roadways and adjacent areas to a database. The database may be local and stored on the vehicle. In some embodiments, illustrated processing block 404 also processes the scanned roadways and adjacent areas to determine features and stores the features. Illustrated processing block 406 determines if a deviation from historical records exists. For example, processing block 406 determines if the scanned roadways and adjacent areas are dissimilar from historical records and/or data. The historical records may be stored locally on the vehicle. If not, illustrated processing block 402 continues to scan the roadway and adjacent areas. Illustrated processing block 408 identifies and records any new points-of-interest (POI) that exist. Points-of-interest include lane deviations, lane marking modifications, new obstacles (e.g., potholes) on roadways, new signage, new barriers, and personnel.

Illustrated processing block 410 determines if any historical POI is removed. For example, a historical POI may include a lane being removed, lane markings being removed, obstacles being removed, signage being removed, barrier removal and personnel removal.

If not, illustrated processing block 424 machine learns and processes confirmation of the modified area. Illustrated processing block 412 receive an operator confirmation of the modified area. Illustrated processing block 414 saves the modified area to a cloud. The cloud may process the modified area in a crowd-sourced fashion by aggregating sensor data from a plurality of vehicles. In some embodiments, processing block 412 is omitted.

Otherwise, illustrated processing block 416 machine learns and processes confirmation of the modified area. Illustrated processing block 418 receives an operator confirmation of the modified area. Illustrated processing block 420 saves the modified area to the cloud similarly to as above. Illustrated processing block 422 transfers the modified area to infrastructure so that the infrastructure takes appropriate action. In some embodiments, processing block 418 is omitted. In some embodiments, the modified area includes confirmation of new roadside units, new lane markings, and usage information to support calibration and retuning of traffic signal cycling, etc.

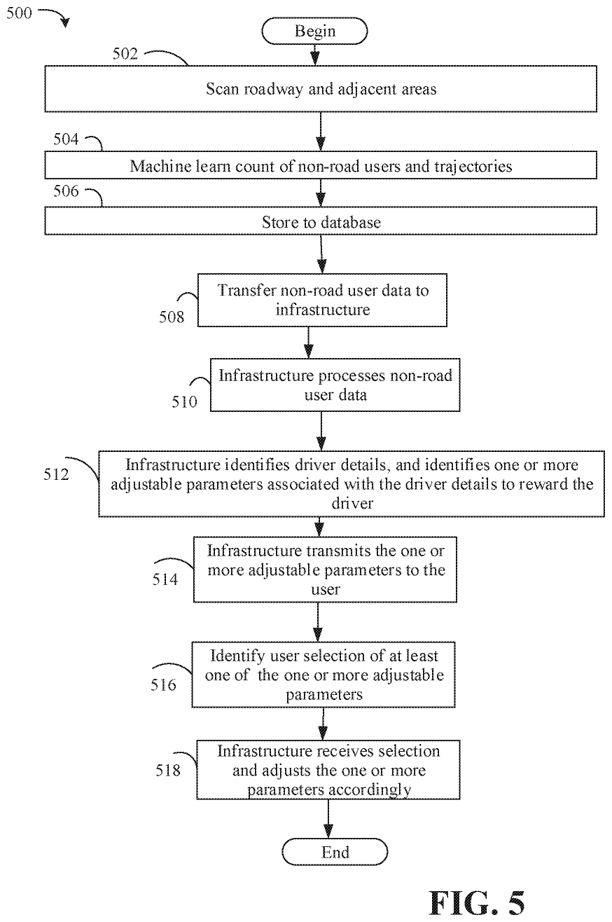

FIG. 5 illustrates a method 500 of V2I non-road user and roadway information sharing. The method 500 may generally be implemented in infrastructure and/or a vehicle. In an embodiment, the method 500 is implemented in logic instructions (e.g., software), configurable logic, fixed-functionality hardware logic, etc., or any combination thereof. In some examples, method 500 is implemented by the V2I system 100 (FIG. 1).

Illustrated processing block 502 scans a roadway and adjacent areas. For example, processing block 502 includes using a camera, a LiDAR sensor, radar scanner, etc. to scan the roadways and adjacent areas. Additionally, processing block 502 identifies information associated with the vehicle, such as vehicle position, vehicle proximity to infrastructure, vehicle speed, steering angle, vehicle heading, lane selection, nearby vehicle positions, proximity of nearby vehicles, estimated trajectories of nearby vehicles, road signs, crosswalk users, sidewalk users and so forth.

Illustrated processing block 504 executes a cloud-based machine learning count of non-road users and trajectories. Illustrated processing block 504 receives crowd-sourced information and sensor data to execute the machine learning. Illustrated processing block 506 stores the non-road users and trajectories to a database, which may be on a vehicle or in infrastructure.

Illustrated processing block 508 transfers non-road user data to infrastructure. Illustrated processing block 510 includes the infrastructure processing the non-road user data. Illustrated processing block 512 includes the infrastructure identifying driver details, and identifies one or more adjustable parameters associated with the driver details (e.g., one or more parameters associated with a unique identifier identified from a vehicle of the user) to reward the driver. The one or more parameters can be related to trajectory prioritization, toll reduction, prioritized parking guidance and/or prioritized parking reservations (e.g., increase priority of the driver to enable faster parking at cheaper costs). Illustrated processing block 514 includes the infrastructure transmitting the one or more adjustable parameters to the user. Illustrated processing block 516 includes identifying a user selection of at least one of the one or more adjustable parameters. The selection may occur through a human-to-machine interface. Illustrated processing block 518 includes infrastructure receiving the selection and adjusting the one or more parameters accordingly.

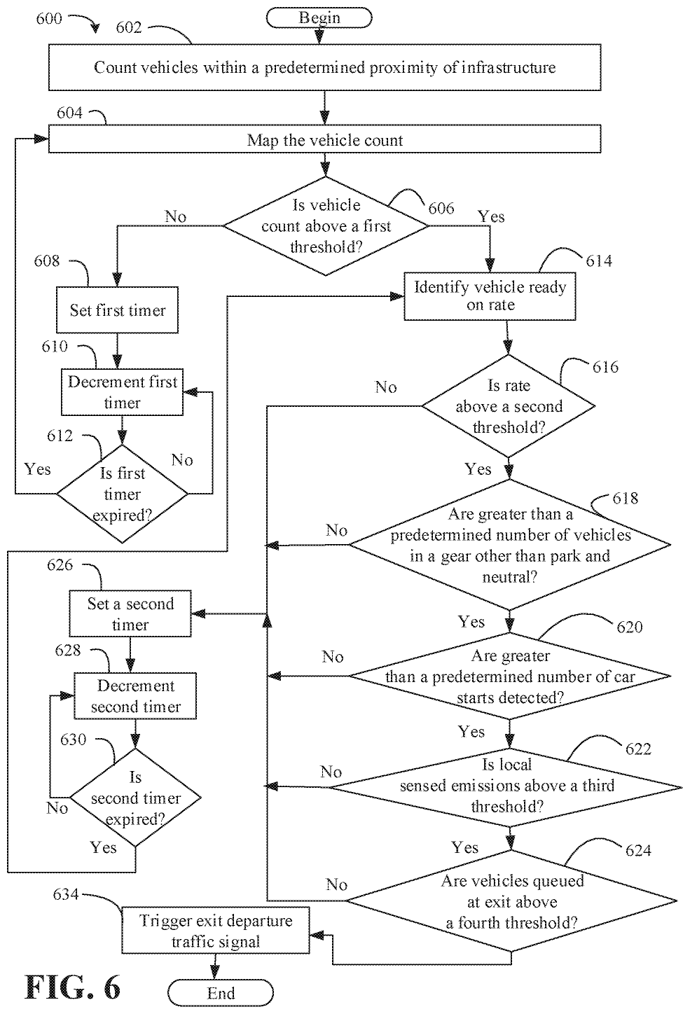

FIG. 6 illustrates a method 600 of V2I of information sharing during an event that will generate a significant increase in traffic. The method 600 may generally be implemented in infrastructure and/or a vehicle. In an embodiment, the method 600 is implemented in logic instructions (e.g., software), configurable logic, fixed-functionality hardware logic, etc., or any combination thereof. In some embodiments, the method 600 is implemented in the V2I system 200.

Illustrated processing block 602 counts vehicles within a predetermined proximity of infrastructure. In some embodiments, illustrated processing block 602 identifies a vehicle positions and/or proximity to infrastructure, vehicle ready on statuses, vehicles gear position, vehicle count, historical records, vehicle idle time history, infrastructure traffic cycles, public transit proximity and expected schedules, nearby vehicle positions, proximity, estimated trajectories, parked vehicle route information (e.g., NAVI-based), vehicle ready on microphone arrays, infrastructure queue length, infrastructure-based vehicle emissions, etc.

Illustrated processing block 604 maps the vehicle count (e.g., determines a density of the counted vehicles within a certain area around the infrastructure). Illustrated processing block 606 determines if the vehicle count is above a first threshold. If not, illustrated processing block 608 sets a first timer. Illustrated processing block 610 decrements the first timer. Illustrated processing block 612 determines if the first timer is expired. If not, illustrated processing block 610 executes again. Otherwise, illustrated processing block 604 executes.

If processing block 606 determines that the vehicle count is above the first threshold, illustrated processing block 614 identifies a vehicle ready on rate (e.g., a number of actuations of the vehicles). Illustrated processing block 616 determines if the rate is above a second threshold. If so, illustrated processing block 618 determines if greater than a predetermined number of vehicles are in a gear other than park and neutral (e.g., determines if the vehicles are in a gear associated with movement). If so, illustrated processing block 620 determines if greater than a predetermined number of car starts are detected. If so, illustrated processing block 622 detects if the local sensed emissions are above a third threshold. If so, illustrated processing block 624 determines if the vehicles queued at an exit (e.g., a venue exit or a parking lot exit) are above a fourth threshold. If so, illustrated processing block 634 triggers an exit departure traffic signal(s) to execute prioritized signaling.

Otherwise, illustrated processing block 626 sets a second timer. Illustrated processing block 628 decrements the second timer. Illustrated processing block 630 determines if the second timer is expired. If not, processing block 628 executes. Otherwise, processing block 634 executes.

It will be understood that modifications to method 600 are apparent. For example, some embodiments omit and/or rearrange one or more of processing blocks 616, 618, 620, 622, 624.

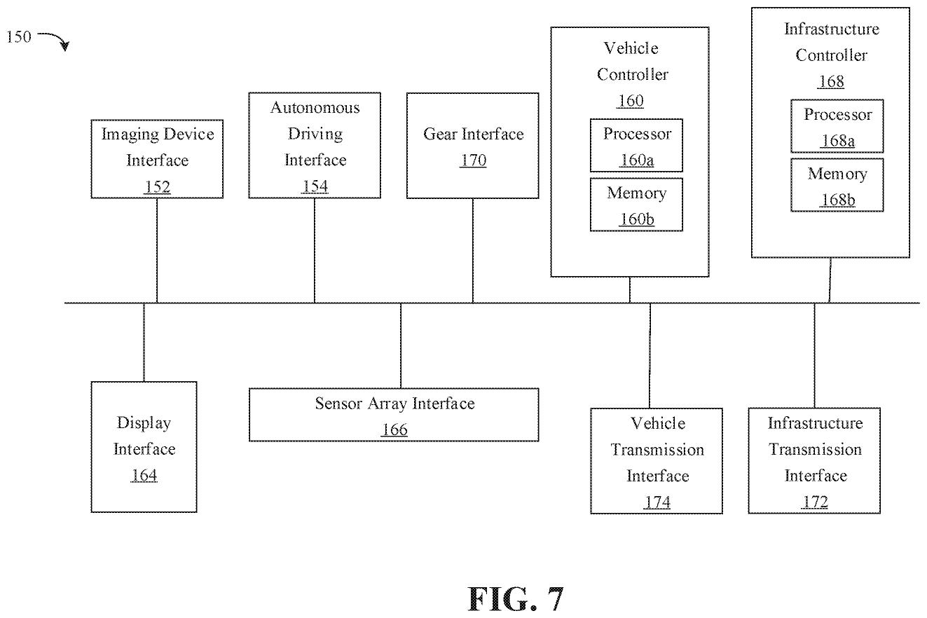

FIG. 7 shows a more detailed example of a V2I system 150 to execute V2I processes as described herein. The illustrated V2I control system 150 may implement aspects of the V2I system 100 (FIG. 1), V2I system 200 (FIG. 2), the reporting process 300 (FIG. 3) already discussed, and may execute any of the methods 400 (FIG. 4), 500 (FIG. 5), 400 (FIG. 4), 500 (FIG. 5) and/or 600 (FIG. 6) in combination or separately.

In the illustrated example, the V2I system 150 may include an imaging device interface 152. The imaging device interface 152 may receive images from an imaging device of a vehicle and as related to a surroundings of the vehicle. The V2I system 150 may further include an autonomous driving interface 154 to control autonomous driving of a vehicle based on communications from infrastructure. The V2I system 150 further includes a display interface 164 to provide adjustable parameters to a user. The parameters may be provided in response to the user participating in the V2I process as described herein. The display interface 164 may receive a selection from the user of at least one of the one or more parameters.

The V2I system 150 may include a sensor array interface 166 that interfaces with a plurality of sensors, for example a global positioning system sensor, proximity sensor, image sensor, to obtain sensor data. The sensor array interface 166 may interface with any type of sensor suitable for operations as described herein. A gear interface 170 also detects a currently engaged gear of the vehicle.

Additionally, a vehicle controller 160 may include a processor 160a (e.g., embedded controller, central processing unit/CPU) and a memory 160b (e.g., non-volatile memory/NVM and/or volatile memory) containing a set of instructions, which when executed by the processor 160a, cause the vehicle controller 160 to process image data to detect image objects, POIs and/or modifications to roadways and POIs as described herein.

Additionally, an infrastructure controller 168 (e.g., a server) may include a processor 168a (e.g., embedded controller, central processing unit/CPU) and a memory 168b (e.g., non-volatile memory/NVM and/or volatile memory) containing a set of instructions, which when executed by the processor 168a, cause the infrastructure controller 168 to process sensor data from the sensor array interface 166 to detect objects, POIs and/or modifications to roadways and POIs, process gear data from the gear interface 170 to detect a currently engaged gear of the vehicle, provide the one or more parameters to the display interface 164, receive the selected at least one parameters from the user, and adjust traffic flows as described herein. In some embodiments the infrastructure controller 168 may interface with the autonomous driving interface 154 to control a path of the vehicle.

In some examples, the infrastructure controller 168 receives processed data from the vehicle controller 160. The processed data may include detected objects, detected POIs and/or detected modifications to roadways and POIs.

In some embodiments, a vehicle transmission interface 174 facilitates communication between the vehicle controller 160 and the infrastructure controller 168. For example, the vehicle controller 160 may route a transmission to the infrastructure controller 168 through the vehicle transmission interface 174. The vehicle transmission interface 174 may in turn transmit (e.g., wired or wirelessly) the transmission to an infrastructure transmission interface 172. The infrastructure transmission interface 172 may receive the transmission and then route the transmission to the infrastructure controller 168. Similarly, the infrastructure controller 168 may reverse the above in order to transmit a transmission to the vehicle controller 160 through the infrastructure transmission interface 172 and the vehicle transmission interface 174.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present disclosure can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing device comprising:
a transmission interface to receive a transmission;
a processor; and
memory having a set of instructions, which when executed by the processor, cause the computing device to:
identify that the transmission includes one or more of vehicle sensor data sensed by a vehicle or at least one feature identified from the vehicle sensor data, wherein the vehicle is associated with vehicle identification data unique to the vehicle;
identify that the vehicle identification data is associated with the transmission;
identify one or more parameters that are associated with the vehicle identification data; and
adjust at least one parameter of the identified one or more parameters.

2. The computing device of claim 1, wherein the transmission interface receives a first transmission from a first vehicle and a second transmission from a second vehicle,
wherein the instructions, when executed, cause the computing device to:
identify an object from the first transmission;
identify the object from the second transmission;
aggregate features from the first and second transmissions to generate aggregated data; and
determine one or more of a velocity or trajectory of the object from the aggregated data.

3. The computing device of claim 1, wherein the transmission interface receives transmissions from a plurality of vehicles,
wherein the instructions, when executed, cause the computing device to:
determine whether to trigger a traffic signal to permit traffic based on a number of vehicles identified from the transmission.

4. The computing device of claim 1, wherein the transmission interface receives vehicle sensor data from a plurality of vehicles,
wherein the instructions, when executed, cause the computing device to:
determine whether to trigger a traffic signal to permit traffic based on auditory signals identified from the vehicle sensor data of the plurality of vehicles.

5. The computing device of claim 1, wherein the transmission interface receives a plurality of transmissions from a plurality of vehicles that are positioned in an area,
wherein the instructions, when executed, cause the computing device to:
identify currently engaged gears of the plurality of vehicles based on the plurality of transmissions; and
determine based on the currently engaged gears of the plurality of vehicles whether to trigger a traffic signal to permit the plurality of vehicles to exit the area.

6. The computing device of claim 1, wherein the transmission interface transmits the one or more parameters to the vehicle and receives a transmission from the vehicle;
wherein the instructions, when executed, cause the computing device to:
identify a selection of the at least one parameter from the transmission from the vehicle.

7. The computing device of claim 1, wherein:
the vehicle sensor data is associated a first traffic signal; and
the one or more parameters are associated with a second traffic signal.

8. A vehicle comprising:
a transmission interface that transmits a first transmission to a computing device;
a sensor to detect vehicle sensor data; and
a vehicle controller including:
a processor; and
memory having a set of instructions, which when executed by the processor, cause the vehicle controller to:
determine whether or not the vehicle sensor data includes updated data dissimilar from historical data; and
determine that the updated data is to be part of the first transmission in response to the vehicle sensor data being determined to include the updated data, wherein the updated data is one or more of the vehicle sensor data or one or more features identified from the vehicle sensor data that are dissimilar from the historical data.

9. The vehicle of claim 8, wherein the instructions, when executed, cause the vehicle controller to:
identify one or more objects from the vehicle sensor data; and
determine that the identified one or more objects are to be part of the first transmission.

10. The vehicle of claim 9, wherein the instructions, when executed, cause the vehicle controller to:
determine one or more of a velocity or trajectory of the one or more objects; and
determine that the one or more of the velocity or the trajectory is to be part of the first transmission.

11. The vehicle of claim 8, wherein the instructions, when executed, cause the vehicle controller to:
receive one or more parameters from the computing device;
present the one or more parameters to a user;
identify a selection from the user of at least one parameter of the one or more parameters; and
determine that the selected at least one parameter is to be part of a second transmission,
wherein the transmission interface transmits the second transmission to the computing device.

12. The vehicle of claim 8, wherein the instructions, when executed, cause the vehicle controller to:
update the historical data based on the vehicle sensor data.

13. The vehicle of claim 8, wherein the vehicle sensor data includes auditory signals, and the instructions, when executed, cause the vehicle controller to:
identify a number of vehicles that are actuated based on the auditory signals; and
transmit the number to the computing device.

14. The vehicle of claim 8, wherein the instructions, when executed, cause the vehicle controller to:
identify that one or more objects in the historical data are not identified from the vehicle sensor data; and
remove the one or more objects from the historical data.

15. At least one computer readable storage medium comprising a set of instructions, which when executed by a computing device, cause the computing device to:
identify that a transmission includes one or more of vehicle sensor data sensed by a vehicle or at least one feature identified from the vehicle sensor data, wherein the vehicle is associated with vehicle identification data unique to the vehicle;
identify that the vehicle identification data is associated with the transmission;
identify one or more parameters that are associated with the vehicle identification data; and
adjust at least one parameter of the identified one or more parameters.

16. The at least one computer readable storage medium of claim 15, wherein the instructions, when executed, cause the computing device to:
identify a first transmission from a first vehicle and a second transmission from a second vehicle;
identify an object from the first transmission;
identify the object from the second transmission;
aggregate features from the first and second transmissions to generate aggregated data; and
determine one or more of a velocity or trajectory of the object from the aggregated data.

17. The at least one computer readable storage medium of claim 15, wherein the instructions, when executed, cause the computing device to:
identify a plurality of transmissions from a plurality of vehicles; and
determine whether to trigger a traffic signal to permit traffic based on a number of vehicles identified from the plurality of transmissions.

18. The at least one computer readable storage medium of claim 15, wherein the instructions, when executed, cause the computing device to:
identify vehicle sensor data from a plurality of vehicles; and
determine whether to trigger a traffic signal to permit traffic based on auditory signals identified from the vehicle sensor data of the plurality of vehicles.

19. The at least one computer readable storage medium of claim 15, wherein the instructions, when executed, cause the computing device to:
identify transmissions from a plurality of vehicles that are positioned in an area;
identify currently engaged gears of the plurality of vehicles based on the transmissions; and
determine based on the currently engaged gears of the plurality of vehicles whether to trigger a traffic signal to permit the plurality of vehicles to exit the area.

20. The at least one computer readable storage medium of claim 15, wherein the instructions, when executed, cause the computing device to:
determine that the one or more parameters are to be transmitted to the vehicle; and
identify a selection of the at least one parameter from a transmission from the vehicle.
